(19) United States
(12) Patent Application Publication
(10) Pub. No.: US 2024/0392396 A1
(43) Pub. Date: Nov. 28, 2024

(54) MIXED IONIC FORM SUGAR CHROMATOGRAPHY

(71) Applicants: DDP SPECIALTY ELECTRONIC MATERIALS US 8, LLC, Wilmington, DE (US); DUPONT TECHNOLOGY (SHANGHAI) CO., LTD., Shanghai (CN)

(72) Inventors: Collin Martin, Wilmington, DE (US); Amanda Hopkins, Wilmington, DE (US); Xiangyang Zhu, Shanghai (CN)

(21) Appl. No.: 18/688,566

(22) PCT Filed: Sep. 14, 2022
(86) PCT No.: PCT/US2022/043501

§ 371 Date: Mar. 1, 2024

(30) Foreign Application Priority Data
Sep. 16, 2021 (WO) PCT/CN2021/118757

(51) Int. Cl. C13K 13/00; B01D 15/36

(52) U.S. Cl. CPC C13K 13/007; B01D 15/362

(57) ABSTRACT

A method for separating sugars, sugar alcohols or a combination thereof by bringing an aqueous solution of sugars, sugar alcohols or a combination thereof into contact with a collection of strong acid cation exchange resin particles, wherein each of the particles comprises from 35 to 85% calcium ions and from 15 to 65% alkali metal ions, as a weight percentage of total metal in the resin particle.

In processes for refining sugars or sugar alcohols, cation exchange resins having metal counterions have been used for chromatographic separations. For example, WO2020/057555A1 discloses chromatographic separation of allulose using cation exchange resins having calcium, sodium, potassium or lithium counterions. A more efficient method for chromatographic separations would be desirable.

The following is a statement of the invention.

A method for separating sugars, sugar alcohols or a combination thereof; said method comprising bringing an aqueous solution of sugars, sugar alcohols or a combination thereof into contact with a collection of strong acid cation exchange resin particles, wherein each of said strong acid cation exchange resin particles comprises from 35 to 85% calcium ions and from 15 to 65% alkali metal ions, as a weight percentage of total metal in the resin particle.

The following is a detailed description of the invention.

As used herein, the following terms have the designated definitions, unless the context clearly indicates otherwise.

As used herein, “sugars” refers to compounds that are monosaccharides, disaccharides, oligosaccharides, or polysaccharides. A monosaccharide is a saccharide compound that cannot be hydrolyzed to a simpler saccharide compound. Monosaccharides include trioses, tetroses, pentoses, hexoses, and heptoses. A disaccharide is a molecule formed when two monosaccharides are joined by a glycosidic linkage. A “sugar alcohol” is a reduced form of a sugar and has the formula CₙH₂ₙ₊₂Oₙ.

“Resin” as used herein is a synonym for “polymer.” Molecules that can react with each other to form the repeat units of a polymer are known herein as “monomers.” The repeat units so formed are known herein as “polymerized units” of the monomer.

Vinyl monomers have a non-aromatic carbon-carbon double bond that is capable of participating in a free-radical polymerization process. Vinyl monomers have molecular weights of less than 2,000. Vinyl monomers include, for example, styrene, substituted styrenes, dienes, ethylene, ethylene derivatives, and mixtures thereof. Ethylene derivatives include, for example, unsubstituted and substituted versions of the following: vinyl acetate and acrylic monomers.

“Substituted” means having at least one attached chemical group such as, for example, alkyl group, alkenyl group, vinyl group, hydroxyl group, alkoxy group, hydroxyalkyl group, carboxylic acid group, sulfonic acid group, amino group, quaternary ammonium group, other functional groups, and combinations thereof.

Monofunctional vinyl monomers have exactly one polymerizable carbon-carbon double bond per molecule. Multifunctional vinyl monomers have two or more polymerizable carbon-carbon double bonds per molecule.

As used herein, vinyl aromatic monomers are vinyl monomers that contain one or more aromatic ring. A polymer in which 90% or more of the polymerized units, by weight based on the weight of the polymer, are polymerized units of one or more vinyl monomers is a vinyl polymer. A vinyl aromatic polymer is a polymer in which 50% or more of the polymerized units, by weight based on the weight of the polymer, are polymerized units of one or more vinyl aromatic monomer. A vinyl aromatic polymer that has been subjected to one or more chemical reactions that result one or more substituent groups (such as, for example, an amino group or a methylene bridge group) being attached to the vinyl aromatic polymer is still considered herein to be a vinyl aromatic polymer. A polymerized unit of a vinyl aromatic monomer that has been subjected, after polymerization, to one or more chemical reactions that result one or more substituent groups (such as, for example, an amino group or a methylene bridge group) being attached to the polymerized unit of the vinyl aromatic monomer is still considered herein to be a polymerized unit of a vinyl aromatic monomer.

A resin is considered herein to be crosslinked if the polymer chain has sufficient branch points to render the polymer not soluble in any solvent. When it is said herein that a polymer is not soluble in a solvent, it means that less than 0.1 gram of the resin will dissolve in 100 grams of the solvent at 25° C.

A collection of resin particles may be characterized by the diameters of the particles. A particle that is not spherical is considered to have a diameter equal to the diameter of a sphere having the same volume as the particle. Particle size is determined using a dynamic imaging particle analyzer, e.g., a FlowCam™ Macro analyzer and the average stated herein as the harmonic mean size (HMS). A useful characterization of a collection of resin particles is D60, which is a diameter having the following property: 60% by volume of the resin particles have diameter below D60, and 40% by volume of the resin particles have diameter of D60 or above. Similarly, 10% of the resin particles by volume have diameter below D10, and 90% of the resin particles by volume have diameter of D10 or above. The uniformity coefficient (UC) is found by dividing D60 by D10. The harmonic mean diameter (HMD) is defined by the following equation:

$$HMD = \frac{n}{{\sum }_{i = 1}^{N} ( \frac{1}{{d}_{i}} )}$$

where i is an index over the individual particles; di is the diameter of each individual particle; and N is the total number of particles.

The Water Retention Capacity (WRC) of a collection of resin particles is a measure of the water molecules that adhere to the resin particles when bulk liquid water has been removed. WRC is measured by removing bulk liquid water from the collection of resin particles and allowing the collection of resin particles to come to equilibrium at room temperature (approximately 23° C.) with air having 100% humidity to produce dewatered moist resin. The dewatered moist resin is weighed, dried, and weighed again. WRC is the weight loss divided by the initial weight, expressed as a percentage.

The surface area of a collection of resin particles is found using the Brunauer-Emmett-Teller (BET) method using nitrogen gas. The BET method with nitrogen gas is also used for characterizing the total pore volume and the average pore diameter of the collection of resin particles.

The resin particles of the present invention comprise one or more polymers. The polymer preferably comprises aromatic rings. Preferred polymers are vinyl polymers; more preferred are vinyl aromatic polymers. Preferably, the total weight of polymerized units of all vinyl aromatic monomers is, by weight of the polymer, at least 75%, preferably at least 85%, preferably at least 90%, preferably at least 92%, preferably at least 93%, preferably at least 94%; preferably at least 96%, preferably no more than 98%, preferably no more than 96%, preferably no more than 94%.

Preferred vinyl aromatic monomers are styrene, alkyl styrenes, and multifunctional vinyl aromatic monomers. Among alkyl styrenes, preferred are those in which the alkyl group has 1 to 4 carbon atoms; more preferred is ethylvinylbenzene. Among multifunctional vinyl aromatic monomers, preferred is divinylbenzene. Preferably the polymer contains polymerized units of multifunctional vinyl aromatic monomer in as amount, by weight based on the weight of polymer, of at least 2%, preferably at least 4%. Preferably the polymer contains polymerized units of multifunctional vinyl aromatic monomer in as amount, by weight based on the weight of polymer, of no more than 8%; preferably no more than 7%, preferably no more than 6%.

Preferably, the polymer either has no groups that contain any atom other than carbon, hydrogen, and nitrogen or else has a total amount of groups that contain one or more atoms other than carbon, hydrogen, and nitrogen of 0.01 equivalents per liter of the collection of resin particles (eq/L) or less; more preferably 0.005 eq/L or less; more preferably 0.002 eq/L or less.

Preferably, each resin particle in the collection of strong acid cation exchange resin particles comprises at least 40% calcium, preferably at least 45%, preferably at least 50%, preferably at least 55%, preferably at least 60%; preferably no more than 80%, preferably no more than 75%, as a weight percentage of total metal in the resin particle. Preferably, each resin particle in the collection of strong acid cation exchange resin particles comprises at least 20% alkali metal cations, preferably at least 25%; preferably no more than 60%, preferably no more than 55%, preferably no more than 50%, preferably no more than 45%, preferably no more than 40%, as a weight percentage of total metal in the resin particle. Preferably, the alkali metal cations are sodium, potassium or a combination thereof. The collection of resin particles of this invention may be used along with other resin particles, but preferably a bed of particles useful for separating sugars, sugar alcohols or a combination thereof comprises no more than 30% of particles other than those of this invention, preferably no more than 20%, preferably no more than 10%, preferably no more than 5%, based on total weight of dry resin particles.

The resin particles of the present invention preferably have water retention capacity of at least 40%, preferably 50% or more. The resin particles of the present invention preferably have water retention capacity of no more than 75%, preferably no more than 70%. Preferably, the resin particles have an exchange capacity of at least 1 eq/L.

Preferably the collection of resin particles has harmonic mean diameter of 150 μm to 700 μm; preferably at least 190 μm, preferably at least 250 μm; preferably no more than 500 μm, preferably no more than 450 μm, preferably no more than 375 μm. Preferably the collection of resin particles has uniformity coefficient of no more than 1.4; preferably no more than 1.3; more preferably no more than 1.2, preferably no more than 1.15.

Preferably the total amount of sugars, sugar alcohols or a combination thereof in the aqueous solution is, by weight based on the weight of the aqueous solution, 10% or higher; preferably 20% or higher; preferably 25% or higher. Preferably the total amount of sugars, sugar alcohols or a combination thereof in the aqueous solution is, by weight based on the weight of the aqueous solution, 75% or less; preferably 60% or less; preferably 50% or less.

Preferably the sugars, sugar alcohols or a combination thereof, comprise at least 20% monosaccharides, preferably at least 40%, preferably at least 60%, preferably at least 80%, preferably at least 90%, by weight based on total weight of sugars, sugar alcohols or a combination thereof. Preferably, the monosaccharides are pentoses or hexoses. Preferably the monosaccharides comprise at least 50% of glucose, fructose, allulose or a mixture thereof, preferably at least 75%, preferably at least 90%, based on total weight of monosaccharides. Preferably the monosaccharides comprise at least 50% of fructose and allulose, preferably at least 75%, preferably at least 90%, based on total weight of monosaccharides.

The aqueous solution may be brought into contact with the collection of resin particles of the present invention by any method. Preferably, after the aqueous solution has been brought into contact with collection of resin particles, the solution is then separated from the collection of resin particles.

A preferred method is to pass the aqueous solution through a fixed bed of the collection of resin particles. The fixed bed is held in a container that holds the collection of resin particles in place while allowing the aqueous solution to enter through an inlet, to make contact with the collection of resin particles, and to exit through an outlet. A suitable container is a chromatography column. When this method is used, the flow rate of aqueous solution through the fixed bed is characterized by bed volumes per hour (BV/hr), where the bed volume (BV) is the volume of the resin in the fixed bed. Preferred flow rates are 0.1 BV/hr or higher; more preferably 0.5 BV/hr or higher. Preferred flow rates are 10 BV/hr or less, more preferably 5 BV/hr or less. Preferably, the aqueous solution is contacted with the collection of resin particles in a simulated moving bed (SMB) configuration, preferably a sequential simulated moving bed (SSMB) configuration (see, e.g., U.S. Pat. No. 9,150,816).

The following are examples of the present invention. Operations were performed at room temperature (approximately 23° C.) except where otherwise stated.

Resin Preparation and Conversion: The resins (all AmberLite CR99 310 resin obtained from DuPont) used in this work were prepared as follows. The “0% Ca” and “100% Ca” resin samples were obtained directly from DuPont as AmberLite CR99 K/310 and AmberLite CR99 Ca/310 respectively. Mixed ionic form resins were prepared by either partially converting AmberLite CR99 K/310 with various amounts of calcium chloride solution or by partially converting AmberLite CR99 Ca/310 with various amounts of potassium chloride. Different amounts of salt were used depending on the degree of ionic conversion desired—for example 4.66 grams of calcium chloride was used per liter of AmberLite CR99 K/310 resin to prepare a 5% Ca resin. Ionic form conversions were done batch wise by stirring 600 mL of resin in 1 liter of deionized water and gradually adding in the appropriate salt with stirring. After salt addition, the mixture was stirred for an additional 30 minutes. The resin was then decanted and washed several times with deionized water to remove any residual salts. The degree of conversion achieved was measured using an EDTA titration described below.

Resin Titration: The resin to be tested was dried to a wet sand or “wetcake” consistency and several grams of resin wetcake were placed in a small container in a vacuum oven set at 110° C. and 25-30 in. Hg vacuum. The resin was dried in the vacuum oven for at least 4 hours until the weight of the resin is constant. The resin was removed from the vacuum oven and, while still warm, was transferred to a dry, sealed glass container and stored prior to titration.

The titration to determine resin calcium level was done as follows: approximately 1 gram of dried resin was weighed out and transferred to a 500 mL Erlenmeyer flask with 150 mL of deionized water and a magnetic stirring bar. Next, 50 mL of 1.0 M sodium chloride solution, 10 mL of a pH 10 0.5M borate buffer solution, and 20 drops of indicator solution (0.5 wt % Eriochrome Black T in 200 proof ethanol) were added to the resin flask in the order listed. The flask is gently stirred using the magnetic stirring bar on a stir plate. An EDTA solution (36.5 grams EDTA tetrasodium salt in 900 mL deionized water) is used to titrate resin samples. This solution is standardized to a known amount of calcium salt prior to the titration of resin samples.

Column Packing Method: Columns of resin were packed into columns for pulse testing as follows: a slurry of 600 mL resin in approximately 1 liter of deionized water was prepared. This slurry was poured into the top of the column until 25% of the column's volume is filled with resin. A soft hammer is used to tap the column to assist in resin settling. Deionized water is then flowed through the partially packed bed at 15 BV/hr for 10 minutes to compact the resin. After compaction, the next 25% of the column's volume is loaded with resin and the compaction procedure is repeated. This process is completed until the entire column is packed. In the case of the layered resin experiment, the bottom 75% of the column was packed with AmberLite CR99 Ca/310 resin (“100% Ca”) while the top 25% of the column was packed with AmberLite CR99 K/310 resin (“0% Ca”). This layering was done carefully so the two different resin layers were not mixed.

Pulse Test: The packed resin column (500-524 mL volume) was heated to 60° C. using a recirculation bath that circulated hot water through a jacket around the resin column. Deionized water was pumped through the resin bed at 2.0-2.5 BV/hr. To start the pulse test, 0.03-0.05 BV (15.0-26.2 mL) of sugar sample was loaded into an injection valve fitted with a sample loop. The injection valve is then switched to the “inject” position and the sample loop containing the sugar sample is placed in-line to the column inlet stream. The sugar sample travels down the resin bed and different sugars separate based on their individual affinities to the stationary resin phase. As the different sugars elute, they are captured by a fraction collector at different time points or fractions. These fractions are then analyzed by HPLC to determine their sugar content.

HPLC Analysis: Sugar samples were analyzed on an Agilent Infinity II 1260 HPLC system using a Bio-Rad Aminex HPX-87C column at 80° C. and a flow rate of 0.4 mL/min. 10 μL of sugar sample was injected per test and was detected using an Agilent G7162A refractive index detector.

SSMB Test: There are various industrial variations of SMB. In this case sequential SMB (SSMB) was used. SSMB divides the continuous FEED/WATER and RAFFINATE/EXTRACT of SMB mode into sub steps. The testing was carried out in SSMB8 (8 resin columns with jackets, 500 ml resin volume/column) mode on the pilot system which was maintained at 55˜60 centigrade. During operation, one cycle consists of 8 steps. Each step consists of 3 sub steps: Sub Step a, is the loop step during which no fluids enters of depart out the system; Sub Step b, ELUENT enters displacing EXTRACT, while FEED enters displacing RAFFINATE 1; Sub Step c, ELUENT goes in and generate RAFFINATE 2. The eight overall steps consist simply of each of these three sub steps applied sequentially through the eight-columns cycle. In Step 1b, ELUENT enters Column 1 while FEED enters Column 5; In Step 2b, ELUENT goes into Column 2 while FEED enters Column 6 and so on. To get good separation, all parameters need to be optimized. In this case, feed concentration was 56 brix. The feed loading ratio was 0.056-0.059 (kg dry target sugar/Liter resin/hour). Water/Feed ratio was 2.1 liters of water (diluent) per liter of feed. Liquid was circulated (recycled) through the SMB at a linear flow rate of 2.6 m/hr. Mass balance samples were taken when the pilot system reached steady state after an adjustment. Usually 5˜6 cycles were needed for equilibration. Samples were taken during Loop sub step. Before the end of the Loop step, the system is paused. Small samples were then collected column by column through T-connections at the bottom of the columns with simultaneous displacement with inlet water from the head of the column through the control panel. About 60 seconds was required to collect each 5˜10 ml sample from each of the 8 columns. After sampling, the process was re-continued. Two containers were used to collect all the EXTRACT and RAFFINATE respectively. In total, 11 samples were collected in total: 8 from the columns plus 3 for FEED, EXTRACT and RAFFINATE. The column sequences in the plots were arranged based on the zones, which means Column 1 and 2 always stand for zone 1 column.

### Pulse Test Data (Non-Allulose):

| | % Ca | | | | | | |
|---|---|---|---|---|---|---|---|
| Compound | Conversion | Peak | Standard | Max. | Peak | Peak | Peak |
| (50 wt % | (by | retention | Dev. | Conc. | Start | End | Width |
| feed) | Titration) | (BV) | (BV) | (Normalized) | (BV) | (BV) | (BV) |
| Sorbitol | 100 | 1.164 | 0.161 | 0.054 | 0.720 | 1.637 | 0.917 |
| | 86.8 | 1.001 | 0.126 | 0.090 | 0.620 | 1.470 | 0.850 |
| | 77.9 | 0.964 | 0.122 | 0.073 | 0.637 | 1.470 | 0.833 |
| | 61.0 | 0.887 | 0.105 | 0.085 | 0.587 | 1.304 | 0.717 |
| | 48.8 | 0.830 | 0.089 | 0.097 | 0.570 | 1.220 | 0.650 |
| | 28.7 | 0.801 | 0.077 | 0.116 | 0.570 | 1.204 | 0.634 |
| | 14.8 | 0.744 | 0.071 | 0.132 | 0.520 | 1.137 | 0.617 |
| | 5.0 | 0.708 | 0.063 | 0.141 | 0.487 | 1.054 | 0.567 |
| | 0 | 0.578 | 0.063 | 0.138 | 0.406 | 0.765 | 0.359 |
| Xylitol | 100 | 1.138 | 0.145 | 0.088 | 0.737 | 1.637 | 0.900 |
| | 86.8 | 0.975 | 0.118 | 0.110 | 0.670 | 1.470 | 0.800 |
| | 77.9 | 0.933 | 0.110 | 0.118 | 0.637 | 1.387 | 0.750 |
| | 61.0 | 0.896 | 0.095 | 0.133 | 0.604 | 1.387 | 0.783 |
| | 48.8 | 0.851 | 0.089 | 0.168 | 0.587 | 1.304 | 0.717 |
| | 28.7 | 0.830 | 0.077 | 0.168 | 0.587 | 1.220 | 0.633 |
| | 14.8 | 0.767 | 0.071 | 0.188 | 0.553 | 1.137 | 0.584 |
| | 5.0 | 0.740 | 0.063 | 0.201 | 0.520 | 1.137 | 0.617 |
| | 0 | 0.605 | 0.063 | 0.196 | 0.438 | 0.798 | 0.360 |
| Maltitol | 100 | 0.820 | 0.148 | 0.116 | 0.520 | 1.387 | 0.867 |
| | 86.8 | 0.727 | 0.122 | 0.141 | 0.487 | 1.304 | 0.817 |
| | 77.9 | 0.704 | 0.114 | 0.149 | 0.470 | 1.220 | 0.750 |
| | 61.0 | 0.685 | 0.100 | 0.174 | 0.454 | 1.220 | 0.766 |
| | 48.8 | 0.656 | 0.089 | 0.188 | 0.437 | 1.137 | 0.700 |
| | 28.7 | 0.665 | 0.077 | 0.212 | 0.454 | 1.137 | 0.683 |
| | 14.8 | 0.623 | 0.071 | 0.233 | 0.437 | 1.020 | 0.583 |
| | 5.0 | 0.608 | 0.063 | 0.253 | 0.437 | 0.970 | 0.533 |
| | 0 | 0.479 | 0.063 | 0.252 | 0.340 | 0.700 | 0.360 |
| Mannitol | 100 | 0.986 | 0.134 | 0.061 | 0.637 | 1.554 | 0.917 |
| | 86.8 | 0.865 | 0.110 | 0.071 | 0.587 | 1.387 | 0.800 |
| | 77.9 | 0.818 | 0.100 | 0.078 | 0.554 | 1.304 | 0.750 |
| | 61.0 | 0.791 | 0.089 | 0.090 | 0.554 | 1.204 | 0.650 |
| | 48.8 | 0.749 | 0.077 | 0.101 | 0.504 | 1.137 | 0.633 |
| | 28.7 | 0.747 | 0.071 | 0.110 | 0.537 | 1.137 | 0.600 |
| | 14.8 | 0.700 | 0.063 | 0.126 | 0.504 | 1.054 | 0.550 |
| | 5.0 | 0.708 | 0.063 | 0.114 | 0.504 | 1.054 | 0.550 |
| | 0 | 0.556 | 0.055 | 0.124 | 0.406 | 0.733 | 0.327 |

Pulse test data with different mixed ionic forms of Amberlite CR99/310. Temperature of 60° C., flowrate of 2 BV/hr (17.5 mL/min), injection volume of 0.05BV (26.2 mL), and column volume of 524 mL.

### Pulse Testing Data for Allulose-Fructose Separation:

| | | Peak | Peak | | | | |
|---|---|---|---|---|---|---|---|
| Compound | | retention | standard | Maximum | Peak | Peak | Peak |
| (30 wt % | | time | deviation | concentration | start | end | width |
| feed) | % Ca | (BV) | (BV) | (Normalized) | (BV) | (BV) | (BV) |
| Allulose | 100 | 1.038 | 0.069 | 0.063 | 0.812 | 1.724 | 0.912 |
| | 80 | 1.021 | 0.080 | 0.070 | 0.764 | 1.628 | 0.864 |
| | 70 | 1.012 | 0.078 | 0.073 | 0.740 | 1.484 | 0.764 |
| | 60 | 0.992 | 0.090 | 0.083 | 0.692 | 1.460 | 0.760 |
| | 50 | 0.960 | 0.097 | 0.093 | 0.644 | 1.364 | 0.720 |
| | 30 | 0.912 | 0.098 | 0.098 | 0.644 | 1.292 | 0.648 |
| | 5 | 0.816 | 0.088 | 0.120 | 0.572 | 1.148 | 0.576 |
| | 0 | 0.814 | 0.090 | 0.127 | 0.572 | 1.124 | 0.552 |
| Fructose | 100 | 0.889 | 0.092 | 0.093 | 0.596 | 1.252 | 0.656 |
| | 80 | 0.839 | 0.097 | 0.130 | 0.596 | 1.228 | 0.632 |
| | 70 | 0.831 | 0.092 | 0.120 | 0.572 | 1.156 | 0.584 |
| | 60 | 0.828 | 0.091 | 0.120 | 0.572 | 1.156 | 0.584 |
| | 50 | 0.823 | 0.088 | 0.126 | 0.548 | 1.132 | 0.584 |
| | 30 | 0.811 | 0.084 | 0.126 | 0.548 | 1.100 | 0.552 |
| | 5 | 0.810 | 0.085 | 0.133 | 0.572 | 1.124 | 0.552 |
| | 0 | 0.605 | 0.079 | 0.136 | 0.572 | 1.100 | 0.528 |

Data with different mixed ionic forms of Amberlite CR99/310. Temperature of 60° C., flowrate of 2.4 BV/hr (20 ml/min), injection volume of 0.03BV (15 mL), and column volume of 500 mL.

### Resolution (R) Values for Allulose-Fructose Separation

| % Ca in resin beads | R |
|---|---|
| 100 | 0.464 |
| 80 | 0.521 |
| 70 | 0.526 |
| 60 | 0.455 |
| 50 | 0.374 |
| 30 | 0.276 |
| 5 | 0.032 |
| 0 | 0.026 |

SSMB data with feed syrup containing 25% allulose and 75% fructose using Amberlite CR99 Ca/310 (100% Ca) and a mixed ionic form beads of Amberlite CR99/310 (70% Ca, 30% K)

| Sample | Feed (brix) | Recycle (m/h) | Loading | W/F ratio |
|---|---|---|---|---|
| 100% Ca | 56 | 2.6 | 0.056 | 2.1 |
| 70% Ca-30% K | 56 | 2.6 | 0.059 | 2.1 |

| | AD (slow moving stream) | | | BD (fast moving stream) | | | |
|---|---|---|---|---|---|---|---|
| | | Allulose | Fructose | | Allulose | Fructose | Allulose |
| Sample | Brix | % | % | Brix | % | % | Recovery % |
| 100% Ca | 10.7 | 98.4 | 1.6 | 28.3 | 1.6 | 98.4 | 94.3 |
| 70% Ca-30% K | 11 | 99.2 | 0.8 | 27.3 | 1.5 | 98.5 | 95.5 |

### Pulse Test Data for Our Invention Using Feed Composition of Patent WO2020057555A1:

| | | Peak | Peak | | | | |
|---|---|---|---|---|---|---|---|
| | | Retention | Standard | Max. | Peak | Peak | Peak |
| | | Time | Deviation | Conc. | Start | End | Width |
| | Compound | (BV) | (BV) | (Normalized) | (BV) | (BV) | (BV) |
| 0% Ca Resin | Maltose | 0.638 | 0.068 | 0.149 | 0.487 | 0.854 | 0.367 |
| | Glucose | 0.736 | 0.064 | 0.147 | 0.554 | 1.070 | 0.516 |
| | Fructose | 0.779 | 0.069 | 0.142 | 0.570 | 1.104 | 0.534 |
| | Allulose | 0.797 | 0.068 | 0.137 | 0.604 | 1.104 | 0.500 |
| 77.9% Ca | Maltose | 0.589 | 0.076 | 0.152 | 0.470 | 0.937 | 0.467 |
| Mixed Ionic | Glucose | 0.659 | 0.064 | 0.152 | 0.487 | 1.037 | 0.550 |
| Form | Fructose | 0.759 | 0.085 | 0.118 | 0.554 | 1.170 | 0.616 |
| | Allulose | 1.009 | 0.131 | 0.084 | 0.720 | 1.387 | 0.667 |
| 100% Ca | Maltose | 0.586 | 0.076 | 0.173 | 0.454 | 1.020 | 0.566 |
| | Glucose | 0.660 | 0.068 | 0.157 | 0.487 | 1.087 | 0.600 |
| | Fructose | 0.777 | 0.094 | 0.112 | 0.554 | 1.187 | 0.633 |
| | Allulose | 1.119 | 0.166 | 0.063 | 0.753 | 1.637 | 0.884 |
| 75% Pure Ca | Maltose | 0.608 | 0.081 | 0.137 | 0.454 | 0.920 | 0.466 |
| Layered with | Glucose | 0.673 | 0.068 | 0.182 | 0.487 | 1.087 | 0.600 |
| 25% Pure K | Fructose | 0.778 | 0.090 | 0.142 | 0.537 | 1.220 | 0.683 |
| | Allulose | 1.038 | 0.138 | 0.069 | 0.720 | 1.537 | 0.817 |

Pulse test peak characteristics for the separation of allulose from maltose, glucose, and fructose for different mixed ionic forms of Amberlite CR99/310. Pulse test with feed of 60% dissolved solids, 14% allulose, 42% glucose, 41% fructose, and 3% maltose. Temperature of 60° C., flowrate of 2 BV/hr (17.5 mL/min), injection volume of 0.05BV (26.2 mL), and column volume of 524 mL.

| | | Peak | Peak | | | | |
|---|---|---|---|---|---|---|---|
| | | Retention | Std | Max. | Peak | Peak | Peak |
| | | Time | Dev. | Conc. | Start | End | Width |
| | Sugar | (BV) | (BV) | (Normalized) | (BV) | (BV) | (BV) |
| (A) 77.9% Ca | Maltose | 0.589 | 0.076 | 0.152 | 0.470 | 0.937 | 0.467 |
| Mixed Ionic | Glucose | 0.659 | 0.064 | 0.152 | 0.487 | 1.037 | 0.550 |
| Form | Fructose | 0.759 | 0.085 | 0.118 | 0.554 | 1.170 | 0.616 |
| | Allulose | 1.009 | 0.131 | 0.084 | 0.720 | 1.387 | 0.667 |
| (B) 75% Pure Ca | Maltose | 0.608 | 0.081 | 0.137 | 0.454 | 0.920 | 0.466 |
| Layered with | Glucose | 0.673 | 0.068 | 0.182 | 0.487 | 1.087 | 0.600 |
| 25% Pure K | Fructose | 0.778 | 0.090 | 0.142 | 0.537 | 1.220 | 0.683 |
| | Allulose | 1.038 | 0.138 | 0.069 | 0.720 | 1.537 | 0.817 |
| Difference | Maltose | 0.019 | 0.005 | −0.015 | −0.016 | −0.017 | −0.001 |
| [(B) − (A)] | | (+3%) | (+7%) | | | | (0%) |
| | Glucose | 0.014 | 0.004 | 0.030 | 0.000 | 0.050 | 0.050 |
| | | (+2%) | (+6%) | | | | (+9%) |
| | Fructose | 0.019 | 0.005 | 0.024 | −0.017 | 0.050 | 0.067 |
| | | (+3%) | (+6%) | | | | (+11%) |
| | Allulose | 0.029 | 0.007 | −0.015 | 0.000 | 0.150 | 0.150 |
| | | (+3%) | (+5%) | | | | (+22%) |
| Conclusions | | Peaks in | Peaks in | No correlation | Peaks in | Peaks in | (B) has |
| | | (B) elute | (B) are 5-7% | in maximum | (A) and (B) | (B) have | wider peaks |
| | | 2-3% slower | broader than | peak heights | start generally | longer | than (A), |
| | | than in (A) | in (A) | between (A) | at the same | elution | effect more |
| | | (e.g. longer | | and (B) | time | tails than | pronounced |
| | | retention in | | | | those in (A), | at higher |
| | | (B) than | | | | particularly | retention |
| | | (A)) | | | | at higher | times |
| | | | | | | retention | |
| | | | | | | times | |

Table comparing the results of the mixed ionic form experiment (A) vs. the layering of two ionically pure resins (B) in a single column using the feed composition in the closest prior art (WO2020057555A1). The results show that the layered resin causes the peaks to elute 2-3% slower (longer retention time=higher eluent usage) and the resulting peaks are 5-7% broader (higher standard deviation). The peak widths in (B) are also up to 22% broader and end at higher bed volume numbers than in (A) because of longer peak tails in (B) vs. (A).

| | Resolution | | | |
|---|---|---|---|---|
| | Coefficients | Glucose | Fructose | Allulose |
| 0% Ca Resin | Maltose | 0.371 | 0.515 | 0.585 |
| | Glucose | | 0.162 | 0.231 |
| | Fructose | | | 0.066 |
| 77.9% Ca Mixed | Maltose | 0.250 | 0.528 | 1.014 |
| Ionic Form | Glucose | | 0.336 | 0.897 |
| | Fructose | | | 0.579 |
| 100% Ca | Maltose | 0.257 | 0.562 | 1.101 |
| | Glucose | | 0.361 | 0.981 |
| | Fructose | | | 0.658 |
| 75% Pure Ca | Maltose | 0.218 | 0.497 | 0.982 |
| Layered with | Glucose | | 0.332 | 0.886 |
| 25% Pure K | Fructose | | | 0.570 |

Pulse test resolution coefficients for the separation of allulose from maltose, glucose, and fructose for different mixed ionic forms of Amberlite CR99/310. Pulse test with feed of 60% dissolved solids, 14% allulose, 42% glucose, 41% fructose, and 3% maltose. Temperature of 60° C., flowrate of 2 BV/hr (17.5 mL/min), injection volume of 0.05BV (26.2 mL), and column volume of 524 mL.

| | Resolution | | | |
|---|---|---|---|---|
| | Coefficients | Glucose | Fructose | Allulose |
| (A) 77.9% Ca Mixed | Maltose | 0.250 | 0.528 | 1.014 |
| lonic Form | Glucose | | 0.336 | 0.897 |
| | Fructose | | | 0.579 |
| (B) 75% Pure Ca | Maltose | 0.218 | 0.497 | 0.982 |
| Layered with 25% | Glucose | | 0.332 | 0.886 |
| Pure K | Fructose | | | 0.570 |
| % Difference | Maltose | 15% | 6% | 3% |
| (A) vs. (B) | Glucose | | 1% | 1% |
| | Fructose | | | 1% |

Table showing that resolution coefficient is better for the mixed ionic form resin (A) vs. pure ionic form resins that are layered sequentially (B).

### Single Bead Ion Exchange Resin SEM-EDS Analysis

Conversion of a single bead of resin compared to entire resin mixture. Single bead data determined from SEM-EDS analysis and resin mixture data determined from a complexometric titration.

| | | | | % Ca | | | % Ca Conversion |
|---|---|---|---|---|---|---|---|
| | | wt % | wt % | Conversion | | Std | Overall (from |
| Sample | bead | Ca | K | Bead | Average | Dev | titration) |
| 1 | 1 | 5.6 | 0.1 | 98.8% | 100.0% | 2.0% | 100% |
| | 2 | 5.8 | 0.1 | 102.4% | | | |
| | 3 | 5.6 | 0.1 | 98.8% | | | |
| 2 | 1 | 5.2 | 2.2 | 91.8% | 90.0% | 3.1% | 86.8% ± 0.8% |
| | 2 | 5.2 | 2.3 | 91.8% | | | |
| | 3 | 4.9 | 1.9 | 86.5% | | | |
| 3 | 1 | 4.7 | 4.7 | 82.9% | 82.4% | 1.0% | 77.9% ± 0.2% |
| | 2 | 4.6 | 3.5 | 81.2% | | | |
| | 3 | 4.7 | 4.6 | 82.9% | | | |
| 4 | 1 | 3.1 | 6.1 | 54.7% | 56.5% | 4.7% | 40.4% ± 0.4% |
| | 2 | 3.5 | 6.9 | 61.8% | | | |
| | 3 | 3.0 | 6.0 | 52.9% | | | |

1. A method for separating sugars, sugar alcohols or a combination thereof; said method comprising bringing an aqueous solution of sugars, sugar alcohols or a combination thereof into contact with a collection of strong acid cation exchange resin particles, wherein each of said strong acid cation exchange resin particles comprises from 35 to 85% calcium ions and from 15 to 65% alkali metal ions, as a weight percentage of total metal in the resin particle.

2. The process of claim 1, wherein said sugars, sugar alcohols or a combination thereof, comprise at least 60% monosaccharides, by weight based on total weight of sugars, sugar alcohols or a combination thereof.

3. The process of claim 2, wherein the strong acid cation exchange resin is a gel resin.

4. The process of claim 3, wherein the collection of resin particles has harmonic mean diameter of 150 μm to 500 μm.

5. The process of claim 4, wherein the monosaccharides comprise at least 50% of glucose, fructose, allulose or a mixture thereof, based on total weight of monosaccharides.

6. The process of claim 1, wherein each of said strong acid cation exchange resin particles comprises from 40 to 80% calcium ions and from 20 to 60% alkali metal ions, as a weight percentage of total metal in the resin particle.

7. The process of claim 5, wherein the strong acid cation exchange resin is a gel resin.

8. The process of claim 6, wherein the collection of resin particles has harmonic mean diameter of 150 μm to 500 μm.

9. The process of claim 7, wherein the collection of resin particles has uniformity coefficient of no more than 1.3.

10. The process of claim 8, wherein said sugars, sugar alcohols or a combination thereof, comprise at least 60% monosaccharides, by weight based on total weight of sugars, sugar alcohols or a combination thereof.

11. The process of claim 9, wherein the monosaccharides comprise at least 50% of glucose, fructose, allulose or a mixture thereof, based on total weight of monosaccharides.
